(19) United States
(12) Patent Application Publication
(10) Pub. No.: US 2021/0032868 A1
(43) Pub. Date: Feb. 4, 2021

(54) ROOF DEBRIS REMOVAL DEVICES

(71) Applicant: Phan Chu, Alameda, CA (US)

(72) Inventor: Phan Chu, Alameda, CA (US)

(21) Appl. No.: 16/938,004

(22) Filed: Jul. 24, 2020

Related U.S. Application Data
(60) Provisional application No. 62/879,729, filed on Jul. 29, 2019.

(51) Int. Cl. E04D 15/00; E04D 13/00; E04D 13/10; H02K 7/06

(52) U.S. Cl. CPC E04D 15/006; H02K 7/063; E04D 13/106; E04D 13/004

(57) ABSTRACT

Devices and methods for removing material from a slanted roof. The devices include motorized unbalanced rotors in a mounting frame adapted to mounting to roof structural features. The methods include mounting the devices to roof structures and actuating the motor, generating vibrations that are propagated to the roof surface to disengage undesirable debris, such as snow.

### PRIORITY

This application claims the benefit of co-pending patent application 62/879,729 filed Jul. 29, 0219 by the same inventors and is included by reference as if fully asset forth herein.

### FIELD OF THE INVENTION

The present disclosure relates to devices and methods of removing debris, such as snow and ice, from a slanted roof. The devices attached to roof structures (such as rafters) can include motorized rotation of unbalanced rotors providing substantial vibrations to a roof. In the methods, the devices are mounted onto, e.g., roof rafters, and the devices are activated to generate vibrations, disengaging debris from contact with the roof upper surface, allowing gravity to direct the debris off of the slanted roof.

### BACKGROUND OF THE INVENTION

Undesired materials on a slanted roof can cause problems ranging from a nuisance, structural damage, to a safety risk. Insects and birds may construct nests on roofs. A buildup of snow can endanger the structure of a roof and lead to collapse. Ice falling from eves can strike persons and objects below.

In many cases, undesired materials on a roof require a person to climb onto the roof and physically remove the debris. For example, a person may remove snow by standing on the slanted roof and shoveling the snow off to the ground below. However, this is difficult work, and it is not uncommon for the person to fall from the slanted roof along with the snow.

In U.S. Pat. No. 8,689,500 to Clifford, a device is described in which concussions are imparted to a roof by a motorized lever/fulcrum (seesaw) arrangement with hammers on each end. The device is mounted to the underside center of roof decking to knock loose ice and snow from the upper side of the roof. This solution may be a bit too complicated, prone to break down, require close adjustment, and does not appear very suitable for mounting on other than flat sections of metal roof decking. The arrangement does not appear efficient at agitating the sturdier locations on the roof upper surface.

It would be desirable to have a debris removal technique that is both safe and effective. In view of the above, a need exists for a simple and flexible system for removing debris from slanted roofs. We believe benefits could also be realized through systems that are adjustable and capable of focusing energy on trouble spots. It would be desirable to employ systems that can provide optimal energy at roof locations resistant to adequate vibration. The present disclosure provides these and other features that will be apparent upon review of the following.

### SUMMARY OF THE DISCLOSURE

The present disclosure includes systems and methods of removing debris from a slanted roof using devices that impart vibrations to a roof, e.g., at selected locations. The systems use vibration devices mounted to roof frame members to agitate debris off the upper roof surfaces. The methods of the inventions employ the vibration devices in a number of unique ways that address the variety of roofs and debris types.

A device to remove debris from a sloped roof can include, e.g., a mounting frame configured to attach the device directly to rafters of a roof, and a motorized vibrator attached to the mounting frame and comprising a motor configured to rotate an unbalanced rotor. The unbalanced rotor comprises a central axis of rotation and in use the rotor center of mass is not at the central axis of the rotor. In use, rotation of the rotor by the motor produces vibrations in the rotor that are transmitted to the mounting frame and to rafters onto which the mounting frame is attached. The device is typically configured so that vibrations from the rotor are transmitted from the rotor, through mounting frame to a rafter (or other roofing frame of decking feature) when mounted to the rafter (or other roofing frame or decking feature). The device can be configured and mounted so that vibrations from the rotor are transmitted from the rotor, through mounting frame to a surface onto which the frame is mounted, but vibrations are not transmitted to the surface by contact of the rotor with other than the motor or frame.

The vibration devices and methods of use are useful in removal of debris from a slanted roof. For example, the “debris” can include snow, leaves, ice, embers, a pest animal, a nest, and/or the like.

The device motor can be of any suitable type, e.g., a DC electric motor, an AC electric motor, and a motor with a variable pulse width modulation power source, and/or the like. Typically, the motor provides a rotary output, but linear actuations can be utilized in some applications.

The unbalanced rotor can be (or be integral with) the output shaft of the motor. Optionally the unbalanced rotor can be coupled to the output shaft of the motor through a coupling link, a flex shaft, a gear set, and/or the like. In some embodiments, the unbalanced rotor comprises one or more weights extending away from the rotor or shaft central axis. The device is typically not configured to strike any part of the sloped roof when mounted to the sloped roof for use. For example, the vibrations are typically imparted to the roof from the disturbances of a spinning imbalance and not direct contact striking of the roof by the device. Most of the energy of vibration from the unbalanced rotor is usually transmitted to the rafters through the mounting frame. Alternately, the energy can be transmitted directly from the motor to the roof. In many embodiments, the device is mounted to a rafter of a roof, although the device(s) may be mounted to other roof frame structures or to roof decking.

It can be an aspect of this disclosure that two or more devices are mounted to different locations of the roof or a roof frame structure. In this way, e.g., the two or more devices can be configured by mounting location or frequency of rotor rotation to provide harmonic beat frequency antinodes at locations on the roof. Further, the one or more of the devices can have an adjustable rotation frequency, whereby the locations of the antinodes can be manipulated.

Optionally, the device(s) can include a controller adapted to control motor parameters such as motor activation (on/off), motor activation time, motor rotation speed, motor power input, and/or the like.

The present disclosure includes methods of moving debris from a slanted roof. For example, the methods can include providing one or more vibration devices, mounting the one or more devices on one or more rafters of a roof, and applying power to motor. Thereby rotation of the unbalanced rotor generates vibrations which are transmitted to the rafters through the mounting frame, vibrating the roof upper surfaces and discharging the debris from the roof. Optionally, the device(s) are only mounted to rafters. Optionally, the device(s) are mounted to other roof structures besides the rafters, e.g., decking and other roof frame structures.

The devices and vibration system can be configured so that vibrations from the rotor are transmitted from the rotor, through mounting frame (or motor) directly to the rafter. For example, the devices can be adapted so that most of the vibration energy of the rotating unbalanced rotor is transmitted to the roof through the mounting frame. In many cases, the vibrations from the rotor are transmitted from the rotor, through mounting frame to a surface onto which the frame is mounted, but vibrations are not transmitted to the surface by contact of the rotor with other than the motor or frame. For example, the devices may be configured not to strike (e.g., by impact) any part of the sloped roof when mounted to the sloped roof for use. In certain embodiments, the roof is other than a metal roof.

The debris removal systems and devices can be configured to manipulate interactions of independently generated vibrations to focus and/or direct the energy to roof surfaces of particular interest. For example, two or more devices can be configured to provide harmonic beat frequency antinodes at desired locations on the roof by mounting the devices at locations of fixed node positions or by adjusting a frequency of rotor rotation for one or more of the devices. Optionally, the two or more devices can have adjustable rotation frequencies, whereby the locations of the antinodes can be manipulated, focused, or repositioned.

### Definitions

Before describing the present invention in detail, it is to be understood that this invention is not limited to particular devices or methods, which can, of course, vary. It is also to be understood that the terminology used herein is for the purpose of describing particular embodiments only, and is not intended to be limiting. As used in this specification, the singular forms “a”, “an” and “the” can include plural referents unless the content clearly dictates otherwise. Thus, for example, reference to “a surface” can include a combination of two or more surfaces.

Unless defined otherwise, all technical and scientific terms used herein have the same meaning as commonly understood by one of ordinary skill in the art to which the invention pertains. Although any methods and materials similar or equivalent to those described herein can be practiced without undue experimentation based on the present disclosure, preferred materials and methods are described herein. In describing and claiming the present invention, the following terminology will be used in accordance with the definitions set out below.

There are two main types of roofs on structures—flat roofs and sloped roofs. “Sloped roofs” are laid out at an incline (e.g., greater than 3 degrees, 10 degrees, 20 degrees, 30 degrees, 45 degrees or more from horizontal) functioning to promote drainage of rain from the roof and/or to work with shingled surfaces to prevent intrusion of water through the roof. Typical slopped roofs can include, e.g., shed style roofs, gabled roofs, hip roofs, butterfly roofs, gambrel roofs, and the like. Flat roofs are essentially flat horizontal roofs that seal with tar and the like (there may be some shallow gradient in the surface, e.g., to prevent standing water). Sloped roofs include framing components and roof surface features. The framing components include rafters, ridge beams, and the wall top plate. For purposes of this disclosure, “rafters” can include common rafters, jack rafters, hip rafters, internal struts, strutting beams, purlins, trusses, collar ties, and other roof framing elements. The roof surface features can include, e.g., decking, underlayment, 90-pound roll, shingles, and the like.

“Vibrations” in the context of the present inventions are physical vibrations. The vibrations are typically physical oscillations of solid materials such as rafters and roof surfaces. The oscillations can propagate from a source, e.g., a vibration device. The oscillations are typically sine waves, but can have other wave shapes.

A “rotor” includes an object (such as a shaft, cam, wheel, or the like), mounted in a device to rotate about a central axis of rotation. An “unbalanced rotor” is an out of balance rotor, as is understood in the art. For example, an unbalanced rotor can be a rotor configured and mounted so that the central axis of rotation does not correspond with the center of mass of the rotor.

“Debris” as used herein, includes non-roof materials one desires not to be on the roof. The major embodiment is weather and seasonal sourced debris, such as snow, dust, embers, and leaves. Debris can also include the certain animal life, e.g., wished to be removed through physical unbalancing and/or annoyance.

### BRIEF DESCRIPTION OF THE DRAWINGS

FIG. 1 is a schematic diagram of a motor and unbalanced rotor mounted on a lower box section of a mounting frame.

FIG. 2 is a schematic diagram of a closed vibration device.

FIG. 3 is a schematic diagram of an upper cover section of a mounting frame.

FIG. 4 is a schematic diagram of multiple vibration devices mounted to roof rafters.

### DETAILED DESCRIPTION

Generally the devices and methods function to introduce vibrations into a slanted roof of a structure, such as a building. The vibrations act on debris that may be on, e.g., the upper surface of the roof, causing the debris to move down the slanted roof surface. In this way, undesirable debris can be removed from the roof surface.

The devices can be mounted to the roof structure at one or more locations and actuated to generate physical vibrations transmitted to the upper surface of the roof. The device can comprise an unbalanced motor system in a housing, e.g., including an unbalanced rotary rotor. Actuation of the motor results in vibrations that are transmitted from, e.g., the unbalanced rotor, through the motor and/or housing to whatever structure the device is mounted to. In many cases the device is mounted to roof framework structures, such as the rafters. Vibration wavelength interactions between multiple devices on the same roof can be configured to direct vibration energy to desired locations on the roof surface.

The present vibration devices have the advantage that they can be mounted to provide enhanced vibration energy at more strongly supported and stiff locations on the roof, e.g., instead of at those positions most easily vibrated. Meanwhile, the less supported locations receive adequate energy and/or roving peak/node vibration wave foci to provide adequate debris removal energy. The present devices can provide adequate energy to address debris removal from easily cleared surfaces (such as metal surfaces) and also in the more difficult to clear roof top surfaces, such more slate, tile, asphalt or wooden shingles.

### I. Debris Removal Devices.

The devices of the invention typically include an unbalanced rotary motor system in a mounting frame. The devices can further include, e.g., mounting fittings, a power source for the motor, and/or a controller to regulate motor output parameters.

Motors of the device are usually electric motors that rotate an output shaft (e.g., armature axle). The motor can be driven by AC or DC power. In several embodiments, the motor is configured to allow adjustment of output, e.g., a motor powered by variable pulse width modulation. Alternately, the motor can be energized by other than electricity. The motor can have a power output appropriate to the intended roof and debris, e.g., with power ranging from less than 5 W to more than 5 kW, from 25 W to about 2 kW, from about 100 W to 1 kW, or about 500 W.

The motor output drives an unbalanced rotor. The rotor can be a direct extension of the motor shaft, or can be a separate piece connected to the motor output shaft. For example, the motor itself, or the motor shaft, or rotor can be unbalanced so that vibrations are induced when the motor is activated. In many embodiments, the motor output shaft is connected to an unbalanced rotor through a coupling link, flexible shaft, or gear set, and/or the like. The vibrations are most commonly transferred to the roof structures through the mounting frame and not by intermittent contact (e.g., impact) of device elements with the roof.

The unbalanced rotor can be mounted (e.g., in the mounting frame) between bearings establishing a central axis of rotation. The rotor can be a unitary feature with a non-uniform distribution of mass about the central axis of rotation. In many embodiments, the rotor can include a balanced central shaft onto which mass can be non-uniformly (e.g., without radial symmetry of mass) attached. For example, the unbalanced rotor can be a cylindrical rod onto which weights are attached, e.g., by clamping or welding, to create the imbalance. It can be desirable to have the weights removable, exchangeable, and/or capable of reposition, e.g., to adjust the vibration output to a particular roof structure. The unbalanced rotor can have a weight imbalance (e.g., average mass on one side of the rotor central rotation axis greater than for an opposite side) of less than 1 gram to more than 5 kg, from 10 grams to 1 kg, from 30 g to 500 g, or about 100 g. The average distance of the rotor overweight material from the central axis can be from less than 5 mm to more than 30 cm, from 10 mm to 10 cm, or about 20 mm.

The mounting frame can provide a housing for the motor and/or unbalanced rotor, e.g., while also providing fixtures for mounting the device to a roof framework. The mounting frame can include an enclosure to protect the device electronics and moving parts. The mounting frame can include, e.g., one or more flanges, e.g., with holes or slits to receive screws, nails, straps, etc., with which to mount the device to the intended roof frame location.

The mounting frame can provide a port for electric power wiring and/or control communications wiring to enter the device. Optionally, the mounting frame can enclose a communications broadcast/receiver (blue tooth, wi-Fi, etc.) for remote control of the device parameters (e.g., on/off, power, frequency).

The mounting frame can provide the functions of the motor housing and/or provide shaft/rotor support. For example, the mounting frame can provide mounting for the motor, bearing locations for the motor shaft, and/or bearing locations for the unbalanced rotor.

The device can include electronic control features. The vibration parameters of the device can be variable and, e.g., subject to remote control. For example, a custom controller, or smart device application, can signal the device to turn on, activate on a set schedule, set a rotor rotation speed, and/or roam through a range of rotation speeds. The controller can be addressable so that multiple devices can be controlled independently or as a group.

This disclosure includes multiple devices mounted to frame members of the same roof. Two or more devices can be mounted at different locations in the rafters to expand the roof top surface area subject to the debris clearing vibrations. Two or more devices can send out vibrations that result in tunable zones of constructive and destructive interference. Zones of constructive interference can be made to roam to different locations depending on, e.g., the locations of the devices and their vibration frequencies.

II. Methods of Debris Removal from Roofs.

Methods of removing debris from slanted roofs can include, e.g., provision of one or more of the vibration devices of this disclosure, mounting the device(s) to frame member(s) of the roof, activating the device(s) to generate vibrations in the roof, e.g., whereby loose debris on the upper surface of the roof lose contact with the surface and slide down the roof under the influence of gravity. Optionally, the methods include calculated or empirically determined combinations of frequency/location/power for multiple devices, e.g., to generate debris removing constructive interference of vibrations, e.g., while providing destructive interference (reduced vibrations) at roof locations that may be sensitive to damage from excessive vibrations.

The methods can be useful in removing a variety of undesired debris from a slanted roof. For example, “debris” removable using the present devices can include snow, leaves, ice, embers, a pest, a nest, and/or the like. The debris may be agitated loose from the upper roof surface by the vibrational motion of the surface. The debris may move down the roof a desired distance, fall off the edge of the roof or into a rain gutter. Benefits can also be realized in the vibrations rendering the environment of the roof undesirable to pests or as habitation for animals.

A first step in practicing the methods of removing debris from a roof is the provision of the vibrating devices described herein. The devices typically include a motor and unbalanced rotor mounted within amounting frame enclosure, as described herein.

The devices are mounted to the rafters of a roof. The devices typically have a flat surface to mate up with a flat rafter surface, and features (such as flanges, holes, or slots) that interact with fittings to mount the device onto the rafter. It is often efficient to mount the devices near the center of a rafter, e.g., where there is less stiffness and immovable oscillation nodes are unlikely to exist. In certain embodiments, two or more devices are mounted to rafters at different locations on the roof. Multiple devices can enhance the power of vibrations and present the possibility of tuning oscillations to direct greater vibration intensity to where it will do the most good in disrupting debris.

Power is provided to actuate the vibration devices. The type of power depends on the type of motor driving the rotor in the device. Typically the motor is electric and receives AC or DC current, e.g., through power wires connected to batteries or a commercial utility. In many cases, it is desirable to provide a variable range of power to the devices. For example, the power supply can have a variable output to adjust the intensity or frequency of output vibrations. One way to accomplish this is by using a variable pulse width modulation power source to actuate the device motor. Electric motors can be powered by an electric utility, batteries, photovoltaics, and/or the like. The devices can optionally be fueled motors, e.g., running on hydrocarbons.

Device controllers can range from simple on/off switches to remote control variable power sources configured with software programs. In many cases, a simple power switch will suffice, e.g., where a homeowner notices that excess snow and ice has accumulated on his roof. The owner can flip the switch on and turn it off when the snow has been detached from the roof. The attached Appendix may be used to illustrate this process.

The intensity and reach of the debris removal system can be enhanced by use of multiple vibration devices at different locations on the roof and/or roof frame structure.

For example, multiple devices can be located at roof locations with the most common debris accumulation and/or locations most difficult to vibrate (e.g., where frame members interact with roof sheeting or with each other).

In certain embodiments, multiple devices can be configured to interact, providing harmonic beats with more intensity at desired roof surface locations, and/or to provide roaming peak intensities. This can be accomplished by selection of a number of devices, the locations of the devices, the amplitudes of device vibrations, and/or the frequencies of the devices. For example, locating devices at rafters can enhance intensity at these stiffer roof locations. Locating devices across from each other relative to roof decking panels can allow an interaction of the wave sources to result in beat frequencies, and constructive/destructive interference, providing more intense vibrations at particular desired locations on the panel. Further, by varying the frequency of one of more of the multiple vibration devices, one can change the location(s) of vibration nodes and constructive interference peaks. Moreover, one can provide constantly roaming peaks and nodes, e.g., by systematically or randomly changing the frequency of one of more of the multiple devices with time. Optimization of the device interactions can be calculation (considering material resilience, distances, propagation rates, intensities, and such), by empirical observation of adjustment effects, or by simple randomization routines that cover all combinations.

Control of the one or more roof/frame mounted vibration devices can be by on/off switches, variable power input devices, modification of the amount of rotor imbalance, and/or the like. In one embodiment, the devices are controlled by one or more digital or analog controllers that set or adjust these parameters. For example, multiple devices could be wired as a group or separately to each receive instructions from a computerized controller, e.g., setting their intensity and activation schedule. The control system could include one or more receivers (e.g., wi-fi, blue tooth, etc.) that are controlled by a master controller (e.g., smart phone) broadcasting instructions. Optionally, the controller can be a computer hard wired to the devices.

### EXAMPLES

A number of methods and compositions are discussed in the Summary and Detailed Disclosure of the invention. Further details are provided herein and in the Examples section. As would be readily appreciated by the skilled person, the disclosures can be read in combination. The following examples are offered to illustrate, but not to limit the claimed invention.

### Example 1—Rafter Vibrating Device

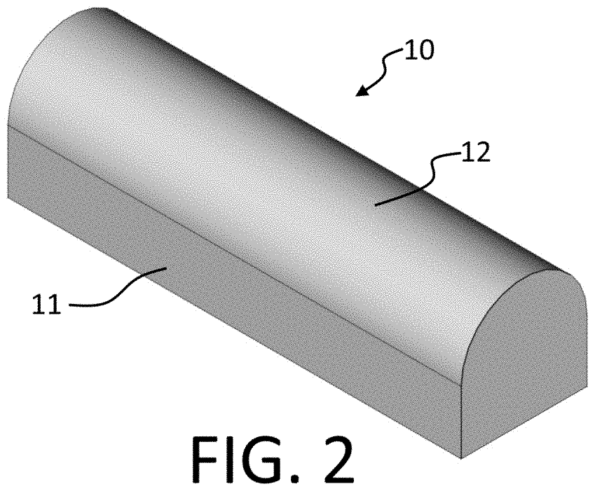

A basic debris removal device can include a mounting frame enclosing a motor with eccentric weights on the motor output shaft (thus, comprising an unbalanced rotor system). For example, as shown in FIG. 2, the mounting frame 10 can be an enclosure that protects the internal device components, and can also act as a frame for mounting the internal components in functional relation with each other. In this example, the mounting frame 10 has a lower box section 11 and an upper cover section 12.

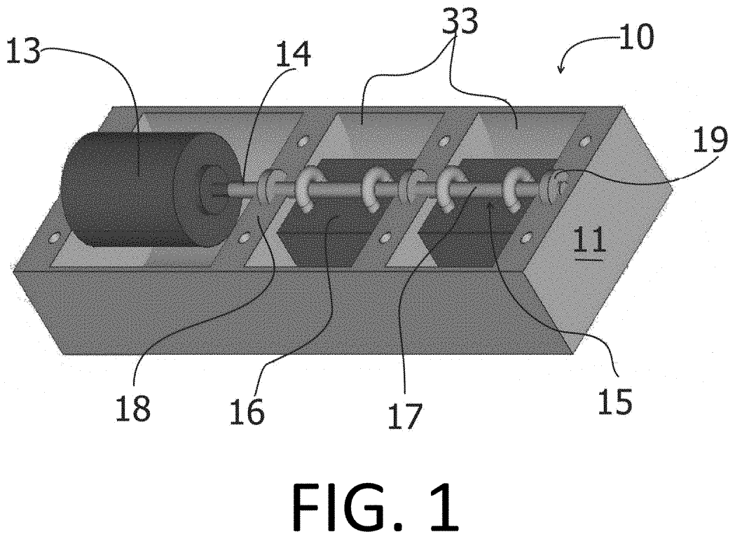

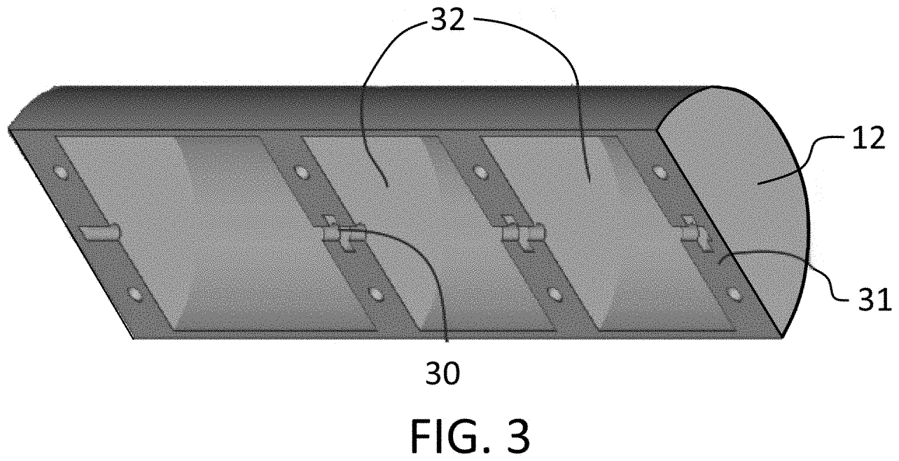

As shown in FIG. 1 with the cover 12 removed, the mounting frame 10 can enclose and mount the motor 13, output shaft 14, and unbalanced rotor 15 (comprising eccentric weights 16 on a vibration shaft 17). Note the mounting frame 10 includes recesses in cross braces 18 to receive shaft bearings 19 (establishing the rotor central axis of rotation). FIG. 3 shows the corresponding cover section 12, with recesses 30 to receive shaft bearings in upper cross braces 31. Upper cavities 32 and lower cavities 33 provide space for the weights 16 to rotate about the vibration shaft 17.

### Example 2—Vibrating Devices Mounted to Slanted Roof Rafters

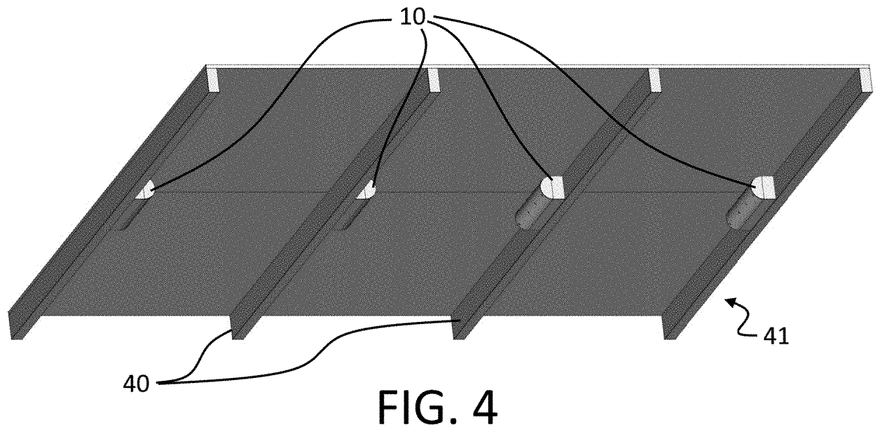

Multiple vibration devices can be mounted to various rafter locations, e.g., as shown in FIG. 4. Shown is the underside of the slanted roof. Individual devices 10 are mounted to separate rafters 40 of slanted roof 41.

In use, the devices could be activated sequentially, or activated two or more at a time. The frequency and/or power of each device can be modulated to result in constructive interference strong vibration zones and/or weak vibration nodes at desired locations in the roof surface.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of this disclosure. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A device to remove debris from a sloped roof, the device comprising:
a mounting frame configured to attach the device directly to rafters of a roof; and, a motorized vibrator attached to the mounting frame and comprising a motor configured to rotate an unbalanced rotor, wherein the unbalanced rotor comprises a central axis of rotation and in use a center of mass for the rotor is not at the central axis of rotation for the rotor;
whereby rotation of the rotor by the motor produces vibrations in the rotor that are transmitted to the mounting frame and to rafters onto which the mounting frame may be attached in use.

2. The device of claim 1, wherein the device is configured so that vibrations from the rotor are transmitted from the rotor, through the mounting frame to a rafter when mounted to the rafter.

3. The device of claim 1, wherein the device is configured so that vibrations from the rotor are transmitted from the rotor, through mounting frame to a surface onto which the frame is mounted, but vibrations are not transmitted to the surface by contact of the rotor with other than the motor or frame.

4. The device of claim 1, wherein the debris is selected from the group consisting of snow, leaves, ice, embers, a pest, and a nest.

5. The device of claim 1, wherein the motor is selected from the group consisting of a DC electric motor, an AC electric motor, and a motor with a variable pulse width modulation power source.

6. The device of claim 1, wherein the rotor is an output shaft of the motor.

7. The device of claim 1, wherein the rotor is coupled to an output shaft of the motor through a coupling link, a flex shaft, or a gear set.

8. The device of claim 1, wherein the unbalanced rotor comprises one or more weights extending away from the rotor central axis of rotation.

9. The device of claim 1, wherein the device is not configured to strike any part of the sloped roof when mounted to the sloped roof for use.

10. The device of claim 1 mounted to a rafter of a roof.

11. The device of claim 10, wherein most of the energy of vibration from the unbalanced rotor is transmitted to the rafters through the mounting frame.

12. Two or more devices of claim 1 mounted to two or more rafters of a roof.

13. The two or more devices of claim 12, wherein the devices are configured by mounting location or frequency of rotor rotation to provide harmonic beat frequency antinodes at locations on the roof.

14. The two or more devices of claim 13, wherein one or more of the devices comprises an adjustable rotation frequency, whereby the locations of the antinodes can be manipulated.

15. The device of claim 1, further comprising a controller adapted to control motor parameters selected from the group consisting of: motor activation (on/off), motor activation time, motor rotation speed, and motor power input.

16. Method of moving debris from a slanted roof, the method comprising:
providing one or more devices of claim 1; and,
mounting the one or more devices on one or more rafters of a roof;
applying power to motor;
whereby rotation of the unbalanced rotor generates vibrations which are transmitted to the rafters through the mounting frame, thereby moving the debris.

17. The method of claim 16, wherein there is no direct mounting of the device to roof structures other than the rafters.

18. The method of claim 16, further comprising configuring the one or more devices so that vibrations from the rotor are transmitted from the rotor, through mounting frame directly to the rafter.

19. The method of claim 16, further comprising configuring the devices so that vibrations from the rotor are transmitted from the rotor, through mounting frame to a surface onto which the frame is mounted, but vibrations are not transmitted to the surface by contact of the rotor with other than the motor or frame.

20. The method of claim 16, wherein the debris is selected from the group consisting of snow, leaves, ice, embers, a pest, and a nest.
